(19) United States
(12) Patent Application Publication
(10) Pub. No.: US 2014/0320638 A1
(43) Pub. Date: Oct. 30, 2014

(54) ELECTRONIC DEVICE AND METHOD FOR DETECTING SURFACE FLAW OF SAMPLE

(71) Applicant: HON HAI PRECISION INDUSTRY CO., LTD., New Taipei (TW)

(72) Inventors: HOU-HSIEN LEE, New Taipei (TW); CHANG-JUNG LEE, New Taipei (TW); CHIH-PING LO, New Taipei (TW)

(73) Assignee: HON HAI PRECISION INDUSTRY CO., LTD., New Taipei (TW)

(21) Appl. No.: 14/258,172

(22) Filed: Apr. 22, 2014

(30) Foreign Application Priority Data
Apr. 25, 2013 (TW) 102114817

(51) Int. Cl. G06T 7/00; G06K 9/20

(52) U.S. Cl. CPC G06T 7/0004; G06K 9/2027; G06T 2207/10004; G06T 2207/10152; G06T 2207/30108
USPC 348/128

(57) ABSTRACT

A method for detecting surface flaws of a sample under test requires a detection device with a motorized horizontal rotating platform. The rotating platform is set to an initial position, and a camera unit of the detection device captures images of the sample. The method adjusts a position of an optical filter of the detection device according to the captured image until intensities of the light source projected on different positions of the sample are uniform. The horizontal rotation platform is further rotated to obtain images of the testing sample at different angles from the camera unit. The method converts colors of specified pixels of the obtained image into a specified color, to obtain processed images. Surface flaws of the processed images are detected, and a result is outputted to a display device.

### FIELD

Embodiments of the present disclosure relate to detection technology, and particularly to an electronic device and method for detecting a surface flaw of a sample using the electronic device.

### BACKGROUND

A testing sample (e.g. a sample of a phone) can include surface flaws. Sometimes a surface flaw cannot be clearly or completely imaged under a light source with a fixed direction. Different images may be generated because of the light source located with different angles. Therefore, it is important to detect the surface flaw of the testing sample.

### BRIEF DESCRIPTION OF THE DRAWINGS

Implementations of the present disclosure will be described, by way of example only, with reference to the following drawings. The modules in the drawings are not necessarily drawn to scale, the emphasis instead being placed upon clearly illustrating the principles of the present disclosure. Moreover, in the drawings, like reference numerals designate corresponding portions throughout the views.

FIG. 1 is a schematic diagram of one embodiment of an electronic device including a surface flaw detection system.

FIG. 2 is a block diagram of one embodiment of function modules of the surface flaw detection system of the electronic device in FIG. 1.

FIG. 3 is a flowchart of one embodiment of a method for detecting a surface flaw using the electronic device of FIG. 1.

FIG. 4 is a schematic diagram of an embodiment of a detection device which is in communication with the electronic device in FIG. 1.

FIG. 5 is a first schematic diagram of an embodiment of an image of a testing sample obtained when a horizontal rotation platform is at an initial position.

FIG. 6 is a second schematic diagram of an embodiment of an image of the testing sample obtained when the horizontal rotation platform is rotated.

FIG. 7 is a first schematic diagram of an embodiment of a processed image of the testing sample without any surface flaw.

FIG. 8 is a second schematic diagram of an embodiment of a processed image of the testing sample including a surface flaw.

### DETAILED DESCRIPTION

The present disclosure, including the accompanying drawings, is illustrated by way of examples and not by way of limitation. It should be noted that references to “an” or “one” embodiment in this disclosure are not necessarily to the same embodiment, and such references can mean “at least one,” or “one or more.”

In the present disclosure, “module,” refers to logic embodied in hardware or firmware, or to a collection of software instructions, written in a program language. In one embodiment, the program language can be Java, C, or assembly. One or more software instructions in the modules can be embedded in firmware, such as in an EPROM. The modules described herein can be implemented as either software and/or hardware modules and can be stored in any type of non-transitory computer-readable media or storage medium. Non-limiting examples of a non-transitory computer-readable medium include CDs, DVDs, flash memory, and hard disk drives.

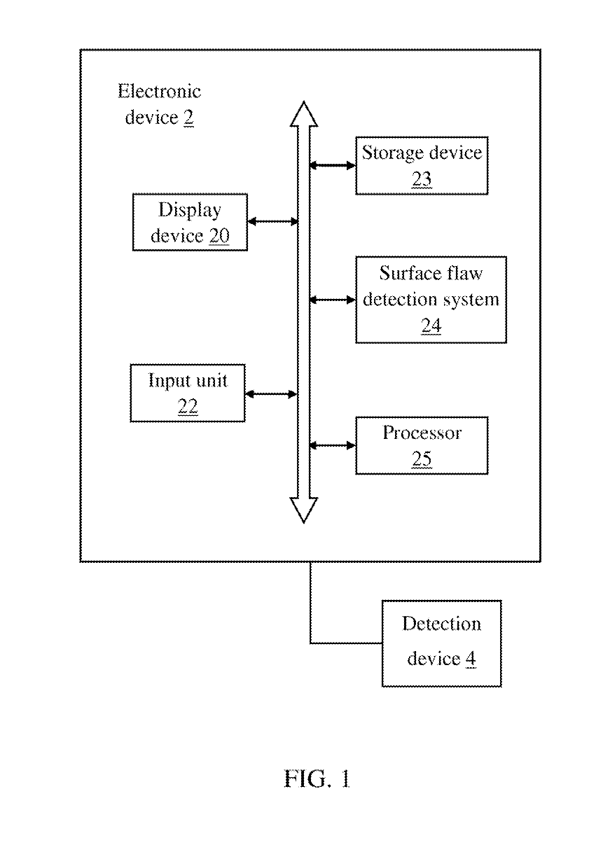

FIG. 1 is a block diagram of one embodiment of an electronic device 2 including a surface flaw detection system 24. In one embodiment, the electronic device 2 may be a tablet computer, a notebook computer, or any other electronic devices. The electronic device 2 includes, but is not limited to, a display device 20, an input unit 22, a storage device 23, and at least one processor 25. The display device 20 displays data of the electronic device 2. The input unit 22 may be a mouse or a keyboard. The at least one processor 25 executes one or more computerized codes and other applications of the electronic device 2, to provide functions of the surface flaw detection system 24. The storage device 23 may be a memory of the electronic device 2 or an external storage card, such as a smart media card or a secure digital card.

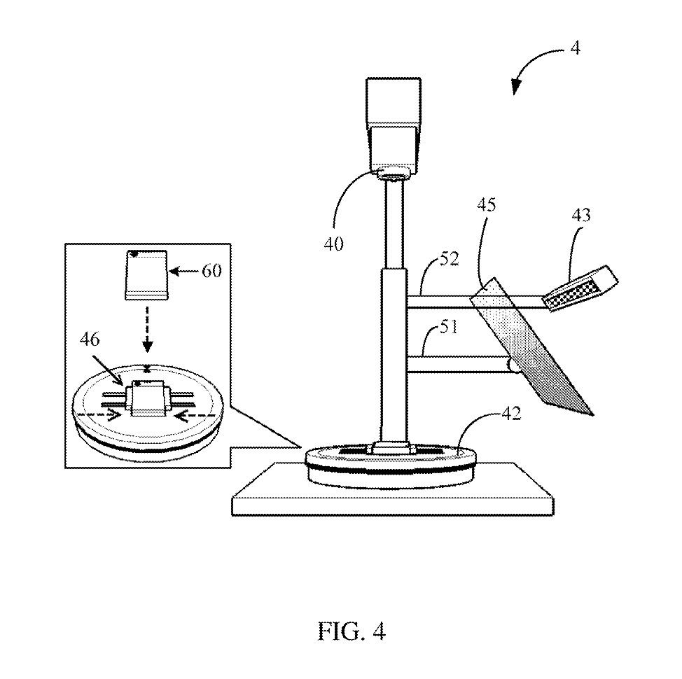

In one embodiment, the electronic device 2 is connected to a detection device 4 through a data cable (not shown). As shown in FIG. 4, the detection device 4 includes, but is not limited to, a camera unit 40, a horizontal rotating platform 42, a light source 43, and an optical filter 45. In one embodiment, the optical filter 45 is a graduated neutral density (GND) filter.

As shown in FIG. 4, a fixed unit 46 is mounted on the horizontal rotation platform 42. A sample under test (testing sample 60) is fixed on the fixed unit 46. The camera unit 40 is positioned directly above the testing sample 60. The light source 40 is positioned at one side above the testing sample 60. The optical filter 45 is positioned between the horizontal rotation platform 42 and the light source 43. The testing sample 60 may be a mobile phone or other manufactured object.

In one embodiment, the horizontal rotation platform 42 is connected to the optical filter 45 through a first connecting rod 51. The horizontal rotation platform 42 is further connected to the light source 43 through a second connecting rod 52. The horizontal rotation platform 42 includes a driving motor for rotating the horizontal rotation platform 42 to adjust positions of the optical filter 45 or the light source 43. The driving motor may be a stepper motor or a servo motor.

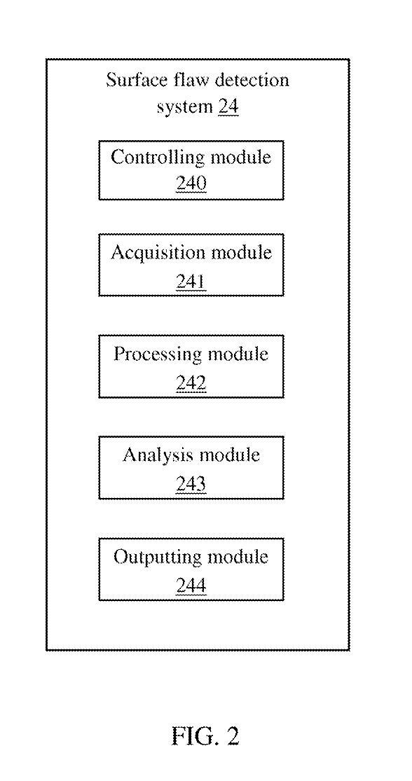

FIG. 2 is a block diagram illustrating function modules of the surface flaw detection system 24. In this embodiment, the surface flaw detection system 24 includes a controlling module 240, an acquisition module 241, a processing module 242, an analysis module 243, and an outputting module 244. The modules 240-244 include computerized code in the form of one or more programs that are stored in the storage device 23. The computerized code includes instructions that are executed by the at least one processor 25 to provide functions of the surface flaw detection system 24. A description of each module of the surface flaw detection system 24 is given in the following paragraphs.

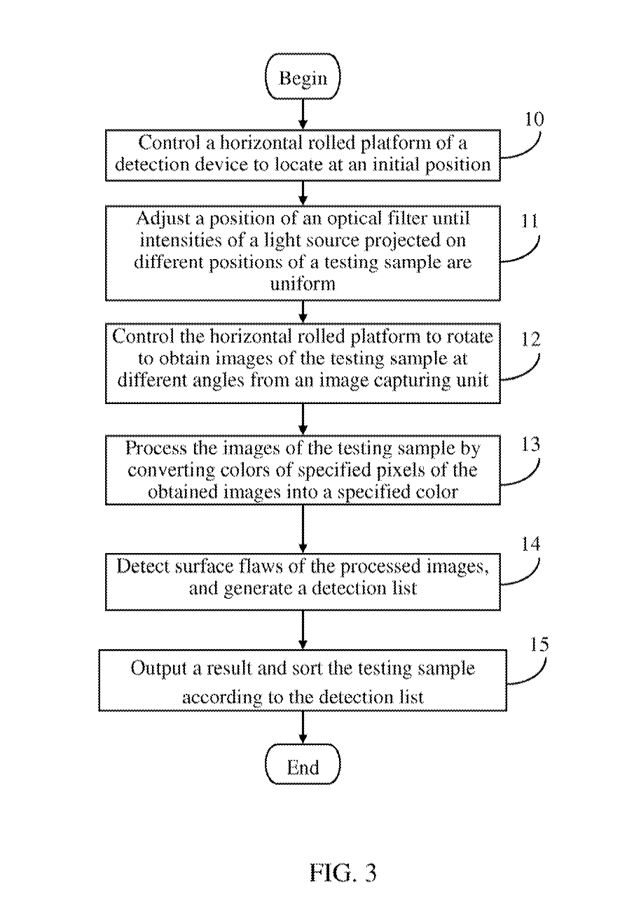

FIG. 3 is a flowchart of one embodiment of a method for detecting a surface flaw of a testing sample using the electronic device 2. Depending on the embodiment, additional blocks may be added, others removed, and the ordering of the blocks may be changed.

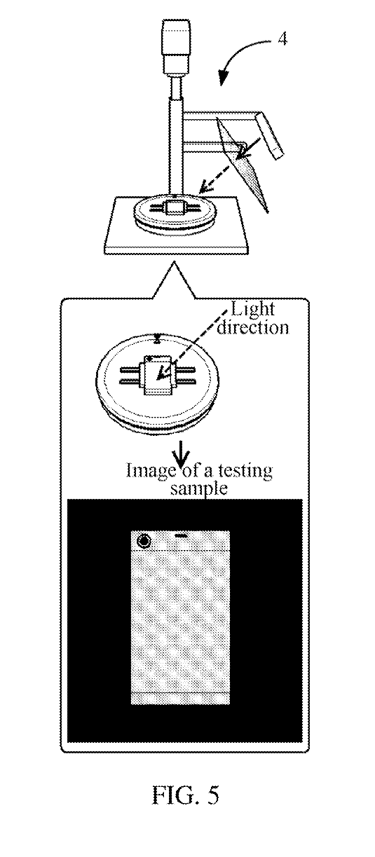

In block 10, the controlling module 240 controls the horizontal rotation platform 42 to locate to an initial position. In one embodiment, the initial position is denoted as a zero starting position of the horizontal rotation platform 42. As shown in FIG. 5, when the horizontal rotation platform 42 is located at the initial position, the testing sample 60 is positioned horizontally and is fixed on the fixed unit 46.

In block 11, the controlling module 240 controls the camera unit 40 to capture an image of the testing sample 60, and adjusts a position of the optical filter 45 according to the captured image until intensities of the light source 43 projecting on different positions of the testing sample 60 are uniform. In one embodiment, when luminance values of all pixels of the captured image are identical, the intensities of the light source projected on different positions are determined to be uniform. If not all of luminance values of the pixels are identical, the intensities of the light source projected on different positions are determined to be not uniform. When a difference of the luminance values between any two pixels is within a predetermined range, the luminance values of all pixels are deemed identical.

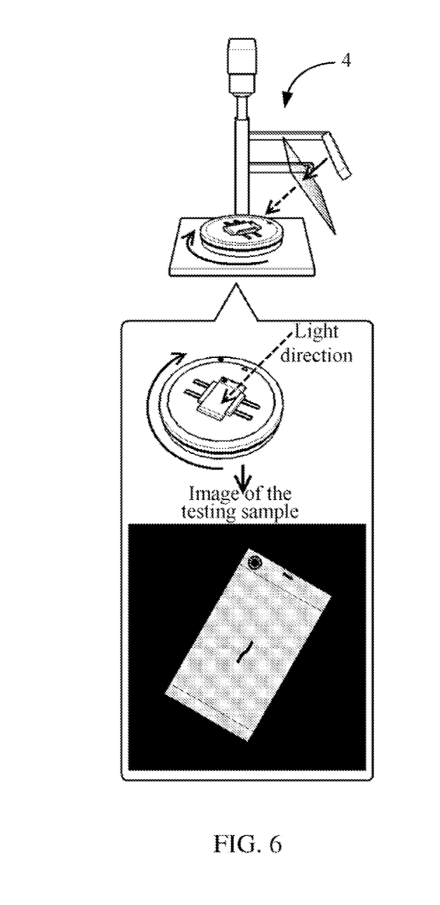

When intensities of the light source 43 projected on different positions of the testing sample 60 are not uniform, the controlling module 240 controls the first connecting rod 51 to move (as shown in FIG. 6) for adjusting the position of the optical filter 45 using the driving motor of the horizontal rotation platform 42. For example, the controlling module 240 adjusts a side of the optical filter with a darker color corresponding to a side of the light source with a stronger projected intensity, for adjusting the intensities of the light source 43 projected onto the testing sample 60. The controlling module 240 stops adjusting the position of the optical filter 45 when the intensities of the light source 43 projected onto the testing sample 60 are uniform.

After intensities of the light source 43 projected on different positions of the testing sample 60 are determined to be uniform, in block 12, the controlling module 240 controls the horizontal rotation platform 42 to rotate, and the acquisition module 241 obtains images of the testing sample 60 at different angles from the camera unit 40 as the horizontal rotation platform 42 rotates. In one embodiment, the controlling module 240 may control the horizontal rotation platform 42 to execute a 360 degree rotation using the driving motor. For example, when the horizontal rotation platform 42 is rotated in an increment of one degree, the camera unit 40 captures two images of the testing sample 60.

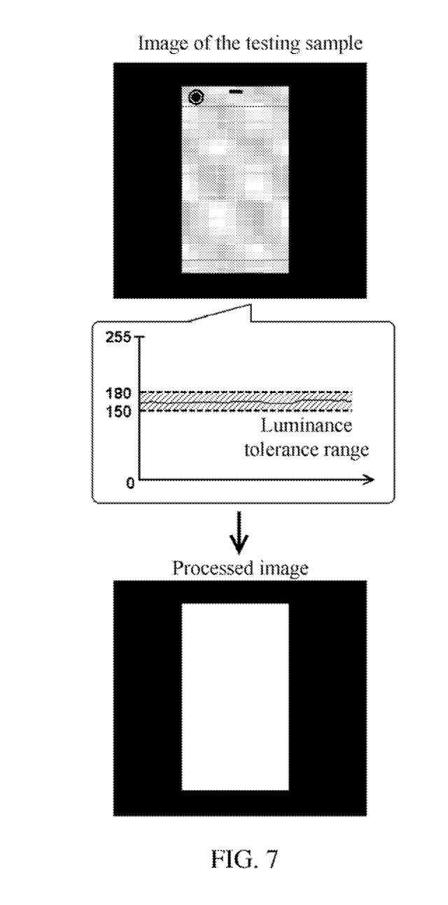

In block 13, the processing module 242 obtains processed images of the testing sample 60 by converting colors of specified pixels of the obtained images into a specified color. In one embodiment, the specified color may be a black color having a luminance value “0” or be a white color having a luminance value “255”. Luminance values of the specified pixels are within a luminance tolerance range. For example, the luminance tolerance range may be set to be between 150 and 180. As shown in FIG. 7, the processing module 242 converts colors of specified pixels of the obtained images into a white color.

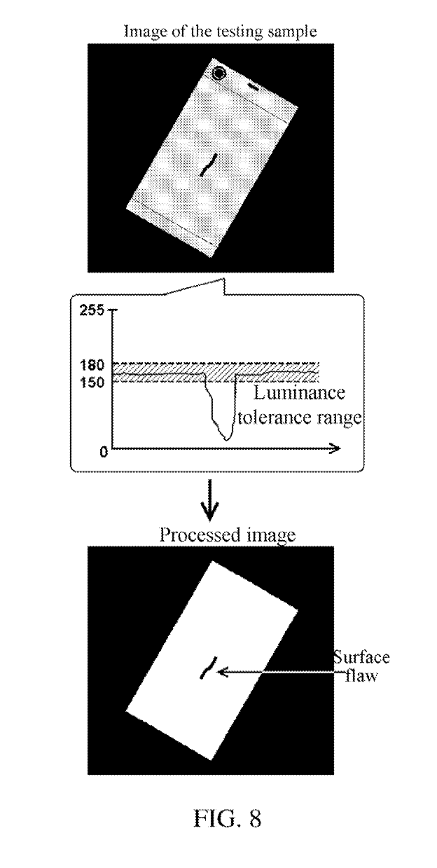

In block 14, the analysis module 243 detects a surface flaw of each of the processed images, and generates a detection list including results of whether each of the processed images includes the surface flaw or not. In one embodiment, when one of the processed images includes one or more luminous points or shadow blocks (as shown in FIG. 8), the analysis module 243 determines that the processed image has the surface flaw. When one of the processed images does not include any luminous point or shadow block (as shown in FIG. 7), the analysis module 243 determines that the processed image have no surface flaw.

If the specified color is a black color, luminance values of the one or more luminous points or shadow blocks are greater than an upper limit of the luminance tolerance range. If the specified color is a white color, the luminance values of the one or more luminous points or shadow blocks are lower than a lower limit of the luminance tolerance range.

In block 15, the outputting module 244 outputs a result to be displayed on the display device 20 according to the detection list, and sorts the testing sample 60 according to the result. In one embodiment, if none of the processed images have any surface flaw in the detection list, the outputting module 244 outputs a result that the testing sample 60 has no surface flaw, and sorts the testing sample 60 to a qualified product. If one or more processed images have the surface flaws in the detection list, the outputting module 244 outputs a result that the testing sample 60 has the surface flaw, and sorts the testing sample 60 to an unqualified product.

In other embodiments, the surface flaw detection system 24 may be in the detection device 4, or some modules of the surface flaw detection system 24 are run in the detection device 4 and other modules of the surface flaw detection system 24 are run in the electronic device 2. For example, the modules of 240-242 are executed by a microprocessor of the detection device 4, and the modules of 243-244 are executed by the processor 25 of the electronic device 2.

All of the processes described above may be embodied in, and fully automated via, functional code modules executed by one or more general purpose processors such as the processor 25. The code modules may be stored in any type of non-transitory readable medium or other storage device such as the storage device 23. Some or all of the methods may alternatively be embodied in specialized hardware. Depending on the embodiment, the non-transitory readable medium may be a hard disk drive, a compact disc, a digital versatile disc, a tape drive, or other suitable storage medium.

The described embodiments are merely examples of implementations, and have been set forth for a clear understanding of the principles of the present disclosure. Variations and modifications may be made without departing substantially from the spirit and principles of the present disclosure. All such modifications and variations are intended to be included within the scope of this disclosure and the described inventive embodiments, and the present disclosure is protected by the following claims and their equivalents.

What is claimed is:

1. An electronic device in communication with a detection device which provides a light source, comprising:
at least one processor; and
a storage device storing one or more programs, which when executed by the at least one processor, cause the at least one processor to perform operations of:
controlling a horizontal rotation platform of the detection device to locate to an initial position;
controlling a camera unit of the detection device to capture an image of a testing sample placed on the detection device, and adjusting a position of an optical filter of the detection device according to the captured image until intensities of the light source projected on different positions of the testing sample are uniform;
controlling the horizontal rotation platform to rotate to obtain images of the testing sample at different angles from the camera unit;
obtaining processed images of the testing sample by converting colors of specified pixels of the obtained image into a specified color, wherein the specified pixels have luminance values within a luminance tolerance range;
detecting surface flaws of the processed images; and
generating a result indicating whether the testing sample has a surface flaw.

2. The electronic device according to claim 1, further comprising:
outputting a result that the testing sample has no the surface flaw and sorting the testing sample to a qualified product, when all of the processed images have no surface flaw; and
outputting a result that the testing sample has the surface flaw and sorting the testing sample to an unqualified product, when one or more processed images have the surface flaws.

3. The electronic device according to claim 1, wherein the intensities of the light source projected on different positions are determined to be uniform when luminance values of all pixels of the captured image from the camera unit are identical.

4. The electronic device according to claim 3, wherein the luminance values of all pixels of the captured image from the camera unit are identical which represents a difference of the luminance value between any two pixels of the captured image being within a predetermined range.

5. The electronic device according to claim 2, wherein the surface flaws of the processed images are detected by:
determining that each of the processed images has the surface flaw, when the each of processed images comprises one or more luminous points or shadow blocks; and
determining that each of the processed images has no surface flaw, when the each of the processed images does not comprise any luminous point or shadow block.

6. The electronic device according to claim 5, wherein when the specified color is a black color, luminance values of the one or more luminous points or shadow blocks are greater than an upper limit of the luminance tolerance range; and
when the specified color is a white color, the luminance values of the one or more luminous points or shadow blocks are lower than a lower limit of the luminance tolerance range.

7. A method for detecting a surface flaw of a testing sample using an electronic device, the electronic device in communication with a detection device which provides a light source, the method comprising:
controlling a horizontal rotation platform of the detection device to locate to an initial position;
controlling a camera unit of the detection device to capture an image of the testing sample placed on the detection device, and adjusting a position of an optical filter of the detection device according to the captured image until intensities of the light source projected on different positions of the testing sample are uniform;
controlling the horizontal rotation platform to rotate to obtain images of the testing sample at different angles from the camera unit;
obtaining processed images of the testing sample by converting colors of specified pixels of the obtained image into a specified color, wherein the specified pixels have luminance values being within a luminance tolerance range; and
detecting surface flaws of the processed images, and generating a result indicating whether the testing sample has a surface flaw.

8. The method according to claim 7, further comprising:
outputting a result that the testing sample has no surface flaw and sorting the testing sample to a qualified product, when all of the processed images do not have the surface flaw;
outputting a result that the testing sample has the surface flaw and sorting the testing sample to an unqualified product, when one or more processed images have the surface flaws.

9. The method according to claim 7, wherein the intensities of the light source projected on different positions of the testing sample are determined to be uniform when luminance values of all pixels of the captured image from the camera unit are identical.

10. The method according to claim 9, wherein the luminance values of all pixels of the captured image from the camera unit are identical which represents a difference of the luminance value between any two pixels of the captured image being within a predetermined range.

11. The method according to claim 8, wherein the surface flaws of the processed images are detected by:
determining that each of the processed images has the surface flaw, when each of the processed image comprises one or more luminous points or shadow blocks; and
determining that each of the processed images have no surface flaw, when the each of the processed image does not comprise any luminous point or shadow block.

12. The method according to claim 11, wherein when the specified color is a black color, luminance values of the one or more luminous points or shadow blocks are greater than an upper limit of the luminance tolerance range; and
when the specified color is a white color, the luminance values of the one or more luminous points or shadow blocks are lower than a lower limit of the luminance tolerance range.

13. A non-transitory storage medium having stored thereon instructions that, when executed by at least one processor of an electronic device, cause the processor to perform a method for detecting surface flaws of a testing sample, the electronic device in communication with a detection device which provides a light source, the method comprising:
controlling a horizontal rotation platform of the detection device to locate to an initial position;
controlling a camera unit of the detection device to capture an image of the testing sample placed on the detection device, and adjusting a position of an optical filter of the detection device according to the captured image until intensities of the light source projected on different positions of the testing sample are uniform;
controlling the horizontal rotation platform to rotate to obtain images of the testing sample at different angles from the camera unit;
obtaining processed images of the testing sample by converting colors of specified pixels of the obtained image into a specified color, wherein the specified pixels have luminance values being within a luminance tolerance range; and
detecting surface flaws of the processed images, and generating a result indicating whether the testing sample has the surface flaw.

14. The storage medium according to claim 13, further comprising:
outputting a result that the testing sample has no surface flaw and sorting the testing sample to a qualified product according to the result, when all of the processed images do not have the surface flaw;
outputting a result that the testing sample has the surface flaw, and sorting the testing sample to an unqualified product, when one or more processed images have the surface flaws.

15. The storage medium according to claim 13, wherein the intensities of the light source projected on different positions of the testing sample are determined to be uniform when luminance values of all pixels of the captured image from the camera unit are identical.

16. The storage medium according to claim 15, wherein the luminance values of all pixels of the captured image from the camera unit are identical which represents a difference of the luminance value between any two pixels of the captured image being within a predetermined range.

17. The storage medium according to claim 13, wherein the surface flaws of the processed images are detected by:
determining each of the processed images has the surface flaw, when the each of processed image comprises one or more luminous points or shadow blocks;
determining each of the processed images has no surface flaw, when the processed image does not comprise any luminous point or shadow block.

18. The storage medium according to claim 17, wherein when the specified color is a black color, luminance values of the one or more luminous points or shadow blocks are greater than an upper limit of the luminance tolerance range;
When the specified color is a white color, the luminance values of the one or more luminous points or shadow blocks are lower than a lower limit of the luminance tolerance range.
